(19) United States
(12) Patent Application Publication
(10) Pub. No.: US 2015/0279554 A1
(43) Pub. Date: Oct. 1, 2015

(54) COMPOSITE COIL MODULE, AND PORTABLE APPARATUS

(71) Applicant: DEXERIALS CORPORATION, Tokyo (JP)

(72) Inventors: Hiroyuki Ryoson, Tochigi (JP); Katsuhisa Orihara, Tochigi (JP)

(21) Appl. No.: 14/428,556

(22) PCT Filed: Oct. 8, 2013
(86) PCT No.: PCT/JP2013/077300

§ 371 Date: Mar. 16, 2015

(30) Foreign Application Priority Data
Oct. 10, 2012 (JP) 2012-225326

(51) Int. Cl. H01F 38/14

(52) U.S. Cl. CPC H01F 38/14

(57) ABSTRACT

A decreased thickness is realized without loss of characteristics of a plurality of coil modules. A first coil module includes a first magnetic sheet made of a first magnetic material, and a first loop coil provided on the first magnetic sheet and wound in a plane. A second coil module includes a second magnetic sheet made of a second magnetic material different from that of the first magnetic sheet, and a second loop coil provided on the second magnetic sheet and wound in a plane. The first magnetic sheet is not provided and the second coil module is provided inside the first loop coil.

### TECHNICAL FIELD

The present invention relates to a composite coil module including coil modules, and particularly to a composite coil module including one loop coil arranged in the inner diameter of another loop coil, and a portable apparatus using the same. The present application claims the benefit of priority from Japanese Patent Application No. 2012-225326, filed on Oct. 10, 2012 in Japan, which is incorporated herein by reference.

### BACKGROUND ART

On recent wireless communication apparatuses, radio frequency (RF) antennas are mounted which include, for example, a telephone communication antenna, a global positioning system (GPS) antenna, a wireless LAN/BLUETOOTH (registered trademark) antenna, and an antenna for radio frequency identification (REID). With the introduction of non-contact charging, loop coils for power transmission have also been mounted in addition to the above antennas. A power transmission system used in a non-contact charging system includes an electromagnetic induction system, a radio wave reception system, a magnetic resonance system, and the like. These systems utilize electromagnetic induction or magnetic resonance between a primary coil and a secondary coil. For example, electromagnetic induction is used in a Qi standard for non-contact charging or near field communication (NFC) standards for the RFID.

### PRIOR ART DOCUMENT

### Patent Document

Patent Document 1: Unexamined Japanese Patent Publication No. 2008-35464

### SUMMARY OF THE INVENTION

### Problems to be Solved by the Invention

With proceeding of miniaturization and high functionality of electronic apparatuses, such as portable terminal apparatuses, the space assigned for mounting the antennas mentioned above has been extremely small. In order to mount an antenna coil for the RFID and a charging coil for non-contact charging together in the same space, there have been high needs for smaller and thinner antenna modules, and compounding and integration of coil modules.

For example, in a composite coil module 100, as shown in FIGS. 12A and 12B, an antenna module 101 for the RFID and a charging module 102 for non-contact charging are stacked and integrated. The antenna module 101 includes a magnetic sheet 103 for magnetic flux convergence made of a magnetic material (e.g., MnZn-based ferrite) suitable for drawing a magnetic field for communication, and an antenna coil 104 formed in a spiral coil by winding a conducting wire in a spiral. The magnetic sheet 103 is adhered with the antenna coil 104 formed in a spiral coil to the entire surface thereof.

In addition, the charging module 102 includes a magnetic sheet 105 for magnetic flux convergence made of a magnetic material (e.g., NiZn-based ferrite) suitable for drawing a magnetic field for charging, and a charging coil 106 formed in a spiral coil by winding a conducting wire in a spiral similar to the antenna module 101. The charging coil 106 has an outer diameter fitted inside the inner periphery of the antenna coil 104. The magnetic sheet 105 is adhered with the charging coil 106 formed in a spiral coil to the entire surface thereof The composite coil module 100 is thus integrated by placing the charging module 102 inside the inner periphery of the antenna coil 104 of the antenna module 101.

However, the modules 101, 102 cannot be thinner due to accumulation of thicknesses of each of the modules 101,102 since these two coil modules 101, 102 are stacked and integrated as mentioned above. Further, a decrease of the diameter of the coil would raise a resistance value to cause high heat, which might be hazardous to both users and other constituent components because a large electric current flows through the non-contact charging coil module. Therefore, the coil is required to have a certain thickness and there are limitations to thinning by stacking and integration is limited.

In addition, in order to achieve thinning, as shown in FIGS. 13A and 13B, a composite coil module 110 has also been proposed, in which the antenna coil and the charging coil are formed on the same flexible print substrate, with a piece of magnetic sheet adhered thereto.

The composite coil module 110 includes an antenna coil 112 formed in a spiral coil to form an antenna module 111, and a charging coil 114 formed in a spiral coil and arranged inside the inner periphery of the antenna coil 112 to form a charging module 113 on a flexible substrate. The antenna coil 112 and the charging coil 114 are made of Cu foil or the like. The composite coil module 110 includes the flexible substrate having the antenna coil 112 and the charging coil 114 formed thereon, and adhered to one side of the magnetic sheet 116 for magnetic flux convergence made of a magnetic material suitable for drawing the magnetic field for communication or charging.

Since the composite coil module 110 uses the magnetic material suitable for drawing the magnetic field for communication or charging for the magnetic sheet 116, however, an RFID communication characteristic would be deteriorated in a case in which a magnetic body most suitable for the non-contact charging coil module (e.g., MnZn-based ferrite) is used. In addition, a non-contact charging characteristic would be deteriorated in a case in which the magnetic body (e.g., NiZn-based ferrite) most suitable for the RFID antenna module is used.

Therefore, an object of the present invention is to provide a composite coil module capable of achieving thinning and being mounted in a small space without loss of each characteristic of coil modules, and a portable apparatus using the composite coil module.

### Means to Solve the Problem

In order to solve the foregoing problems, a composite coil module according to the present invention includes a first coil module including a first magnetic sheet made of a first magnetic material and a first loop coil provided on the first magnetic sheet and wound in a plane, and a second coil module including a second magnetic sheet made of a second magnetic material different from that of the first magnetic sheet and a second loop coil provided on the second magnetic sheet and wound in a plane. The first magnetic sheet is not provided inside the first loop coil, while the second coil module is provided.

A portable apparatus according to the present invention includes a composite coil module mounted on a housing of the apparatus. The composite coil module includes a first coil module including a first magnetic sheet made of a first magnetic material and a first loop coil provided on the first magnetic sheet and wound in a plane, and a second coil module including a second magnetic sheet made of a second magnetic material different from that of the first magnetic sheet and a second loop coil provided on the second magnetic sheet and wound in a plane. The first magnetic sheet is not provided inside the first loop coil, while the second coil module is provided.

According to the present invention, the first magnetic sheet is not provided along the inner periphery side of the first loop coil in the first coil module, while the second coil module is provided. The present invention, therefore, achieves thinning of the entirety of the module, compared to the case where the first coil module and the second coil modules are placed on top of each other. Further, according to the present invention, the first coil module and the second coil module include the first and second magnetic sheets, respectively, with each sheet being made of the most suitable magnetic material. The thinning of the modules can therefore be achieved without loss of module characteristics of each of the modules.

### BRIEF DESCRIPTION OF THE DRAWINGS

FIG. 1A is a plan view illustrating an example of a composite coil module according to an embodiment of the present invention, and FIG. 1B is a cross sectional view thereof.

FIG. 2 is a schematic view illustrating a wireless communication system for RFID using an antenna module.

FIG. 3 is a schematic view illustrating a non-contact charging system using a non-contact charging module.

FIG. 4 is a plan view illustrating an example of a composite coil module according to an embodiment of the present invention.

FIG. 5 is a plan view illustrating an example of a composite coil module according to an embodiment of the present invention.

FIG. 6 is a plan view illustrating an example of a composite coil module according to an embodiment of the present invention.

FIG. 7 is a plan view illustrating an example of a composite coil module according to an embodiment of the present invention.

FIG. 8 is a plan view illustrating a composite coil module placed on a metal plate.

FIG. 9 is a perspective view illustrating a magnetic field intensity distribution on a metal plate.

FIG. 10A is a plan view illustrating an example of a composite coil module to which the present invention has been applied, and FIG. 10B is a cross-sectional view thereof.

FIG. 11A is a plan view illustrating an example of a composite coil module to which the present invention has been applied, and FIG. 11B is a cross-sectional view thereof.

FIG. 12A is a plan view illustrating an example of a conventional composite coil module, and FIG. 12B is a cross-sectional view thereof.

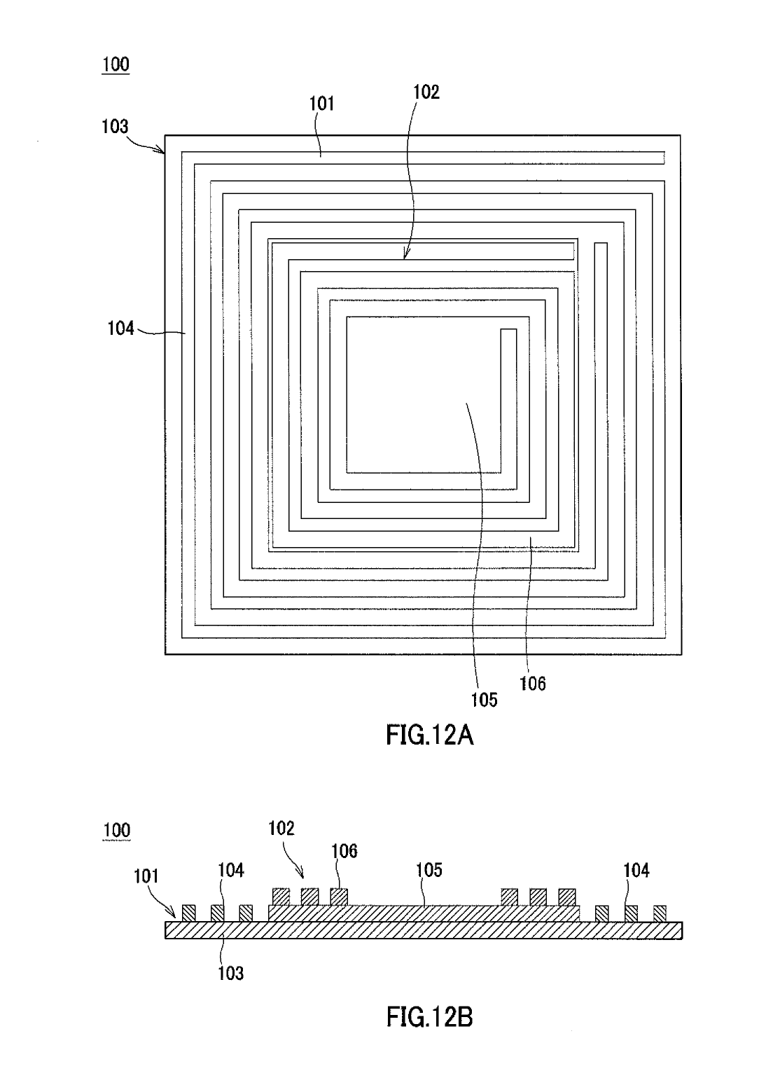

FIG. 13A is a plan view illustrating an example of a conventional composite coil module, and FIG. 13B is a cross-sectional view thereof.

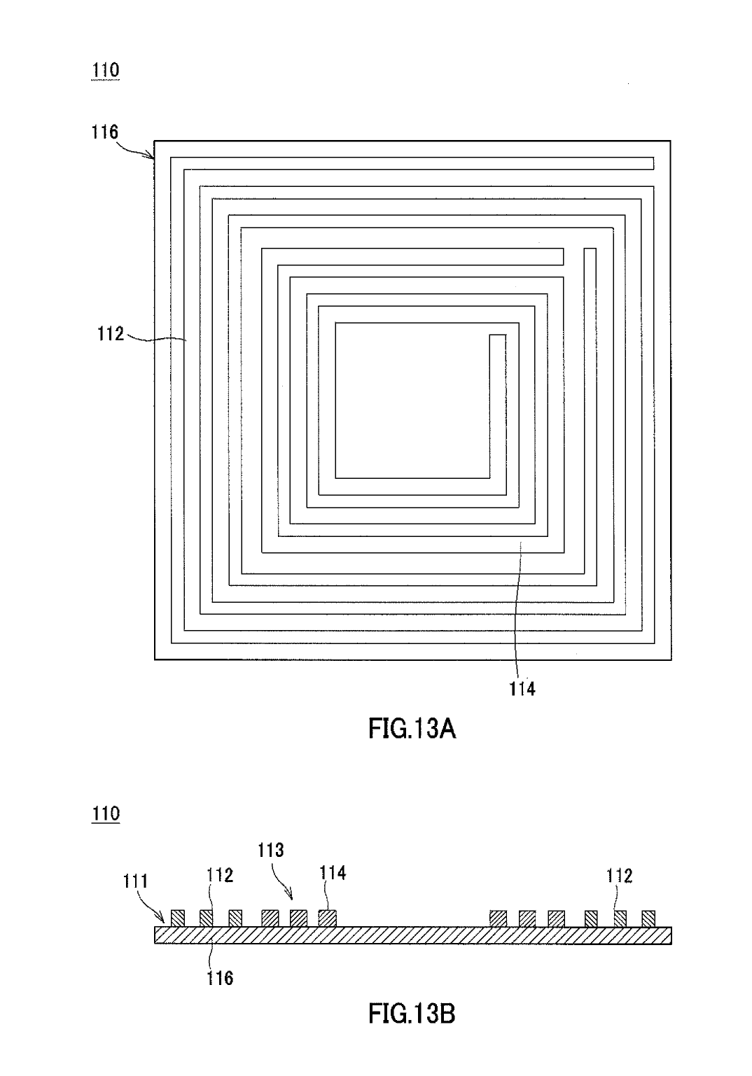

### DESCRIPTION OF THE EMBODIMENTS

A composite coil module and a portable apparatus according to the present invention will be described in detail by referring to the accompanying drawings. It should be understood that the present invention is not limited to the embodiments described below, and various modifications may be made within the range not departing from the spirit of the invention. The accompanying drawings are schematic diagrams, and the dimensional ratio and the like thereof may be different from actual ones. Specific dimensions and the like, therefore, should be determined by considering the following description. It should be understood that the dimensional relationship or ratio may differ in some parts of the drawings.

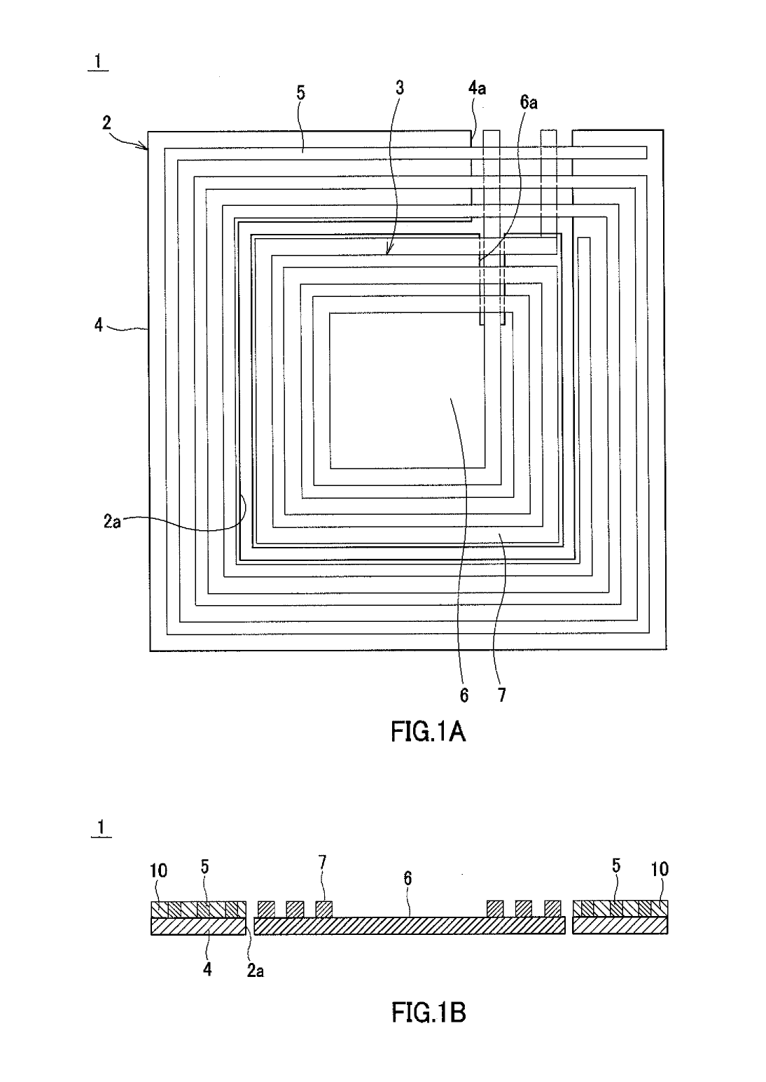

A composite coil module 1 according to an embodiment of the present invention is incorporated into portable electronic apparatuses to achieve both near field wireless communication and non-contact charging characteristics. Specifically, the composite coil module 1 according to an embodiment of the present invention includes, as shown in FIGS. 1A and 1B, an antenna module 2 that serves as a first coil module, and a non-contact charging module 3 provided inside the antenna module 2 and that serves as a second coil module. The antenna module 2 is the RFID module for the NFC and the like, and includes a first magnetic sheet 4 formed in a sheet and made of a magnetic material, and an antenna coil 5 formed in a spiral coil provided on the first magnetic sheet 4 and wound in a plane. The non-contact charging module 3 is a non-contact charging module of, for example, the Qi, and includes a second magnetic sheet 6 formed in a sheet and made of a magnetic material different from that of the first magnetic sheet 4, and a non-contact charging coil 7 formed in a spiral coil provided on the second magnetic sheet 6 and wound in a plane.

[Antenna Module]

The first magnetic sheet 4 is made of, for example, an NiZn-based ferrite sintered body. The first magnetic sheet 4 is formed in a sheet by sintering ferrite particles that have previously been applied thinly in a sheet under a high temperature environment, followed by die cutting the sheet into a predetermined shape. Alternatively, the first magnetic sheet 4 may be formed by previously applying the ferrite particles in a sheet-like manner into a shape similar to a final shape of the sheet before sintering. Furthermore, the first magnetic sheet 4 may also be formed by packing the ferrite particles in a die having a rectangular cross section to sinter the ferrite particles in a cuboid having a rectangular shape in a plan view. The sintered body may also be then thinly sliced to obtain a predetermined shape.

It is noted that the first magnetic sheet 4 may include magnetic particles made of soft magnetic powder and resins as binders.

The magnetic particles used may be made of oxide magnetic bodies such as ferrite; crystal or fine crystal based magnetic bodies such as Fe—, Co—, Ni—, Fe—Ni—, Fe—Co—, Fe—Al—, Fe—Si—, Fe—Si—Al— and Fe—Ni—Si—Al-based magnetic bodies such as Sendust and parmalloy; and amorphous metal magnetic materials such as Fe—Si—B—, Fe—Si—B—C—, Co—Si—B—, Co—Zr—, Co—Nb— and Co—Ta-based magnetic bodies.

Among them, the NiZn-based ferrite mentioned above may preferably be used as a magnetic material in the first magnetic sheet 4 used in the RFID antenna module 2 for the NFC and the like.

Resins and the like that are curable by heat, ultraviolet rays and the like may be used as the binders. The binders used may be made of a well-known material including resins such as an epoxy resin, a phenol resin, a melamine resin, a urea resin, an unsaturated polyester , or rubbers such as a silicone rubber, a urethane rubber, an acrylic rubber, a butyl rubber, an ethylene propylene rubber. It is noted that an appropriate amount of a surface treatment agent such as a flame retardant, a reaction control agent, a crosslinking agent or a silane coupling agent may be added to the above-mentioned resins or rubbers in the binder material.

It is noted that the first magnetic sheet 4 may not limited to be made of a single magnetic material, and two types or more of magnetic materials may be mixed or stacked in a multilayer. The first magnetic sheet 4 may also be made of the same magnetic material, or more than one particle diameters and/or shapes of the magnetic particles may be selected and mixed, or stacked in a multilayer.

The antenna coil 5 is formed by a conductive pattern made of Cu foil and the like on a flexible substrate 10 made of polyimide and the like in a spiral coil.

In the antenna module 2, the first magnetic sheet 4 is formed in an identical shape to that of the flexible substrate 10 of the antenna coil 5. Also in the antenna module 2, an aperture is formed on the inner periphery side of the antenna coil 5 of the flexible substrate 10, while another aperture is formed on the inner periphery side of the antenna coil 5 of the first magnetic sheet 4. This allows an aperture 2a to be formed. The antenna module 2 is provided with non-contact charging module 3 in the aperture 2a thereof.

[Near Field Wireless Communication System]

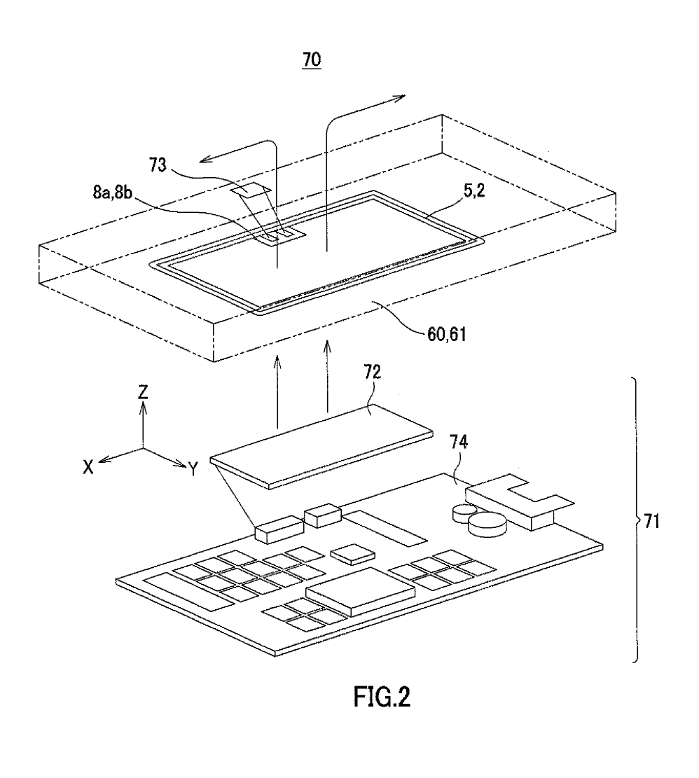

Next, a near field wireless communication characteristic using the antenna module 2 will be described. As shown in FIG. 2, for example, the composite coil module 1 is incorporated in a housing 61 of a portable telephone 60, for example, and the antenna module 2 is used as an RFID wireless communication system 70.

The wireless communication system 70 includes a reader/writer 71 that accesses a memory module 73 incorporated in the portable telephone 60 together with the antenna module 2. It is assumed herein that the antenna module 2 and the reader/writer 71 are arranged so as to face each other in an xy plane of an xyz three dimensional orthogonal coordinate system.

The reader/writer 71 functions as a transmitter that transmits a magnetic field in the z-axis direction toward the antenna coil 5 of the antenna module 2 facing each other in the xy plane. Specifically, the reader/writer 71 is provided with an antenna 72 that transmits the magnetic field toward the antenna coil 5 and a control board 74 that communicates with the memory module 73.

Specifically, the reader/writer 71 is provided with the control board 74 that is electrically connected to the antenna 72. A control circuit including electronic components, such as one or more integrated circuit chips, is mounted on the control board 74. The control circuit executes various types of processing according to data received from the memory module 73 via the antenna coil 5. For example, in transmitting data to the memory module 73, the control circuit encodes the data to modulate a carrier wave of a predetermined frequency (e.g., 13.56 MHz) according to the encoded data, and amplifies a modulated signal after the modulation to drive the antenna 72 using the amplified modulation signal. In addition, to read data out from the memory module 73, the control circuit amplifies the modulated signal of the data received by the antenna 72 and demodulates the modulated signal of the amplified data to decode the demodulated data. It is noted that the control circuit uses encoding and modulating methods that are used in a general reader/writer. For example, the Manchester encoding and/or an amplitude shift keying (ASK) modulation method may be used.

In the antenna module 2, the antenna coil 5 receives a magnetic field transmitted from the reader/writer 71 to establish induction coupling with the reader/writer 71, and supplies a signal to the memory module 73 which is a storage medium incorporated in the portable telephone 60.

Upon receipt of the magnetic field transmitted from the reader/writer 71, the antenna coil 5 is magnetically connected to the reader/writer 71 by induction coupling to receive the modulated electromagnetic wave, and supplies the received signal to the memory module 73 via terminals 8a, 8b.

The memory module 73 is operated by an electric current flowing through the antenna coil 5 and communicates with the reader/writer 71. Specifically, the memory module 73 demodulates the received modulated signal, decodes the demodulated data, and writes the decoded data in an internal memory included in the memory module 73. In addition, the memory module 73 also reads data to be transmitted to the reader/writer 71 from the internal memory, encodes the read data to modulate a carrier wave according to the encoded data, and transmits a radio wave to the reader/writer 71 after the modulation via the antenna coil 5 that has been magnetically connected by induction coupling.

[Non-Contact Charging Module]

The non-contact charging module 3 includes the second magnetic sheet 6 formed in a sheet and made of a magnetic material different from that of the first magnetic sheet 4, and the non-contact charging coil 7 formed in a spiral coil provided on the second magnetic sheet 6 and wound in a plane.

The second magnetic sheet 6 is formed in a size fitted within the aperture 2a of the antenna module 2. In addition, the second magnetic sheet 6, similar to the first magnetic sheet 4, is made of a sintered body of magnetic particles formed in a sheet, and an MnZn-based ferrite, for example, may preferably be used. The second magnetic sheet 6 may be made of an NiZn-based ferrite. The second magnetic sheet 6 can be produced in the same manner as the first magnetic sheet 4.

In addition, the second magnetic sheet 6 may also include, similar to the first magnetic sheet 4, the magnetic particles made of soft magnetic powder and resins as the binders to be formed in a sheet. For the second magnetic sheet 6, the magnetic particles and the binders mentioned above that can be used in the first magnetic sheet 4 can also be used.

In addition, the second magnetic sheet 6 may not limited to be made of a single magnetic material, similar to the first magnetic sheet 4, and two types or more of magnetic materials may be mixed or stacked in a multilayer. The second magnetic sheet 6 may be made of the same magnetic material, or particle diameters and/or shapes of the magnetic particles may be selected and mixed, or otherwise stacked in a multilayered structure.

The non-contact charging coil 7 receives the magnetic field transmitted from the power transmission coil to establish induction coupling, and supplies a charging current to the battery of a portable apparatus in which the composite coil module 1 is incorporated. The non-contact charging coil 7 is formed by a conducting wire, for example, that has been wound in a spiral coil.

The conducting wire constituting the non-contact charging coil 7 may be formed by a single wire made of Cu or an alloy including Cu as a main component having a diameter of 0.20 to 0.45 mm, when the non-contact charging module 3 is used as a secondary charging coil for non-contact charging having an output capacity of, for example, about 5 W, and is used in a frequency range of about 120 kHz. Alternatively, a parallel wire or a braided wire formed by bundling a plurality of thin wires which are thinner than the single wire mentioned above may be used as the conducting wire in order to reduce skin effect. A single layer or two-layer α-winding may also be formed using rectangular wires or flat wires having a decreased thickness. In addition, Cu foil and the like formed in a pattern on the substrate such as a flexible substrate may be used for the non-contact charging coil 7 in accordance with a current capacity.

It is noted that the antenna module 2 and the non-contact charging module 3 are physically separated from each other. Therefore, magnetic coupling between the antenna coil 5 and the non-contact charging coil 7 is weak since the antenna coil 5 and the non-contact charging coil 7 are arranged across air having a low magnetic permeability (i.e., low magnetic resistance). In addition, an insulating material having high magnetic resistance, such as a sub-board made of epoxy, phenol, etc., or a flexible substrate made of polyimide or the like, may be provided between the antenna module 2 and the non-contact charging module 3.

[Non-Contact Charging System]

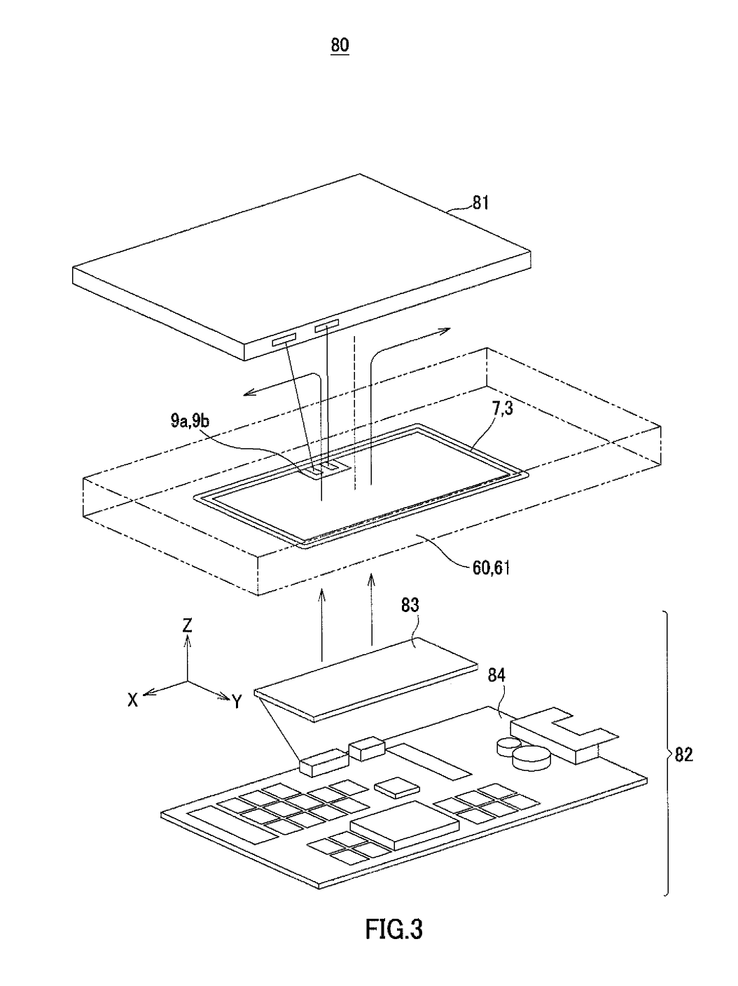

A non-contact charging characteristic using the non-contact charging coil 7 will be described. For example, as shown in FIG. 3, the non-contact charging coil 7 is used as a non-contact charging system 80 according to the Qi standard, for example.

The non-contact charging system 80 is configured to charge, by using a charging device 82, a battery pack 81 connected to the non-contact charging coil 7 of the non-contact charging module 3. It is assumed herein that, similar to the positional relationship of the antenna coil 5 and the reader/writer 71 described above, the non-contact charging coil 7 of the non-contact charging module 3 and a power transmission coil 83 of the charging device 82 are arranged to face each other in the xy plane of the xyz three dimensional orthogonal coordinate system.

The charging device 82 functions as power transmission means that transmits a magnetic field in the z-axis direction toward the non-contact charging coil 7 of the non-contact charging module 3 facing each other in the xy plane. Specifically, the charging device 82 is provided with the power transmission coil 83 that transmits a magnetic field toward the non-contact charging coil 7 and a power transmission control board 84 that is inductively coupled via the power transmission coil 83 to control power supply to the non-contact charging coil 7.

That is, the charging device 82 is provided with the power transmission control board 84 that is electrically connected to the power transmission coil 83. On the power transmission control board 84, a control circuit including electronic components such as one or more integrated circuit chips is mounted. The control circuit supplies a charging current to the non-contact charging coil 7 that has been inductively coupled with the power transmission coil 83. Specifically, the power transmission control board 84 drives the power transmission coil 83 by a power transmission current of a predetermined frequency such as a relatively low frequency of 110 kHz.

As described above, the non-contact charging module 3 is incorporated in the housing 61 of the portable telephone 60. The non-contact charging coil 7 receives the magnetic field transmitted from the power transmission coil 83 to establish inductive coupling with the power transmission coil 83, and supplies the received electric current to the battery pack 81 incorporated in the portable telephone 60.

Upon receipt of the magnetic field from the charging device 82, the non-contact charging coil 7 is magnetically coupled with the charging device 82 by inductive coupling, and receives a modulated electromagnetic wave to supply a charging current to the battery pack 81 via terminals 9a, 9b.

The battery pack 81 applies a charging voltage corresponding to the charging current flowing through the non-contact charging coil 7 to a battery cell inside the battery pack 81.

The composite coil module 1 described above includes the antenna coil 5 achieving the near field wireless communication characteristic, and the non-contact charging coil 7 achieving the non-contact charging characteristic. When incorporated into the portable telephone 60, therefore, it is possible to achieve both the near field wireless communication characteristic and the non-contact charging characteristic, while achieving miniaturization of the housing 61.

In this case, the composite coil module 1 includes the aperture 2a where the first magnetic sheet 4 is not provided, formed along the inner periphery side of the antenna coil 5 of the antenna module 2, and the non-contact charging module 3 is arranged in the aperture 2a. Therefore, the composite coil module 1 achieves thinning of the entirety of the antenna module compared to the case where the antenna module 2 and the non-contact charging module 3 are placed on top each other. In addition, the composite coil module 1 also includes the first magnetic sheet 4 and the second magnetic sheet 6, each using the most suitable magnetic material for the antenna module 2 and the non-contact charging module 3, respectively. This makes it possible to achieve the thinning of the modules without loss of the antenna characteristics and the charging characteristics.

It is noted that, as shown in FIG. 1, the composite coil module 1 may include a cutout 6a formed in the second magnetic sheet 6 to draw an end portion of the non-contact charging coil 7 located at the inner periphery side toward outside. This makes it possible for the composite coil module 1 to draw the end portion of the non-contact charging coil 7 on the inner periphery side toward the same plane as the second magnetic sheet 6, which allows the decrease of the thickness compared to the case where the end portion is drawn toward the outside by placing it on the non-contact charging coil 7.

[Opening]

As shown in FIG. 1, the composite coil module 1 includes an opening 4a formed in the first magnetic sheet 4 and opened over the inner and outer peripheries of the antenna coil 5 to draw the non-contact charging coil 7 to the outside from the opening 4a. This makes it possible to draw both ends 7a, 7b of the non-contact charging coil 7 of the composite coil module 1 to the outside of the module, without increasing the thickness by placing both ends 7a, 7b of the non-contact charging coil 7 on the antenna module 2.

The opening 4a has a width wide enough to pass at least the conducting wire of the non-contact charging coil 7, and may be formed at one or more places of the first magnetic sheet 4.

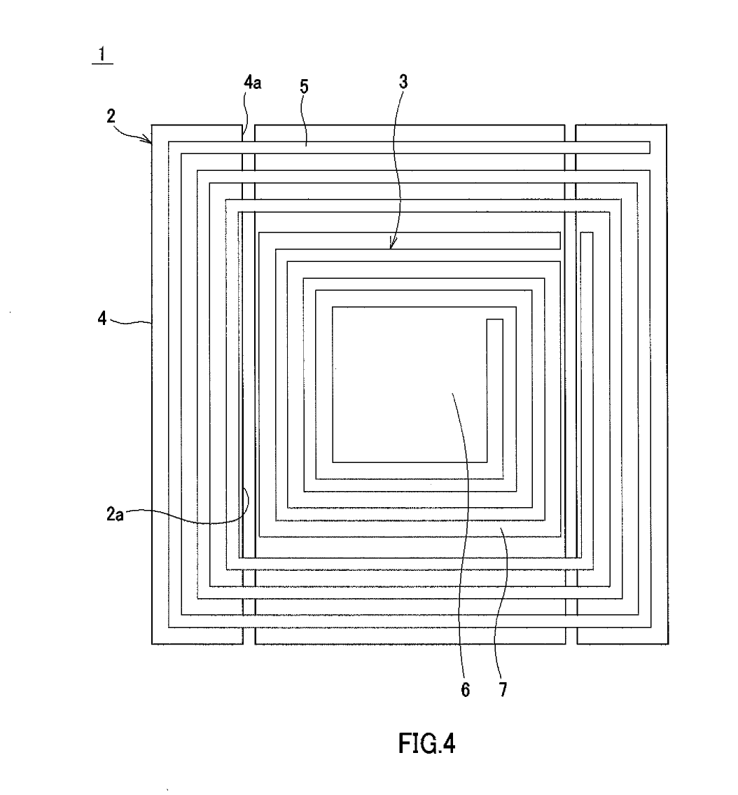

In addition, as shown in FIG. 4, the opening 4a may be formed in the first magnetic sheet of the composite coil module 1 and has a width equal to or wider than that of the non-contact charging module 3, while the opening 4a is also provided with the second magnetic sheet 6 of the non-contact charging module 3. This makes it possible for the composite coil module 1 to have an increased area of the second magnetic sheet 6 of the non-contact charging module 3 and to facilitate the magnetic flux convergence to improve the charging efficiency.

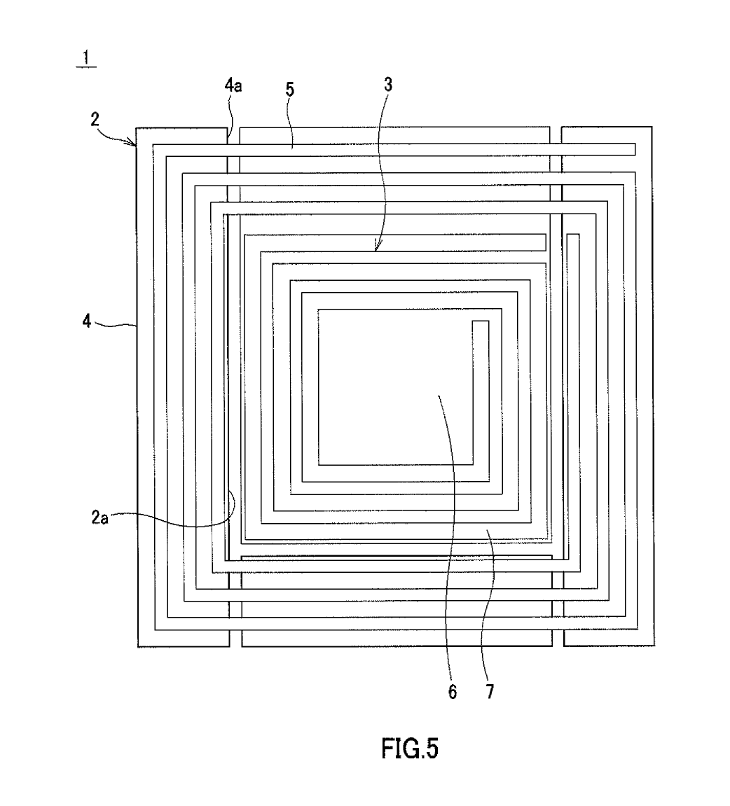

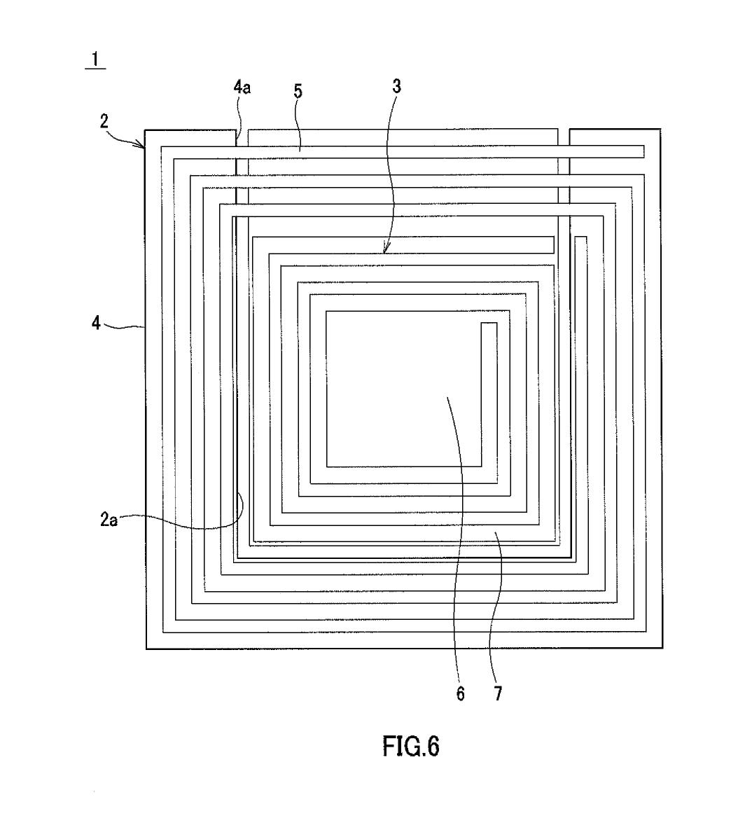

Also in the above-mentioned case, the opening 4a may be provided on one or more sides of the first magnetic sheet 4. In such a case, the opening 4a is provided on one side of the first magnetic sheet 4 of the composite coil module 1, the other three sides may be formed by independent three magnetic sheets, each sheet constituting one side, as shown in FIG. 5. Alternatively, the other three sides may be formed by an integrated magnetic sheet, as shown in FIG. 6.

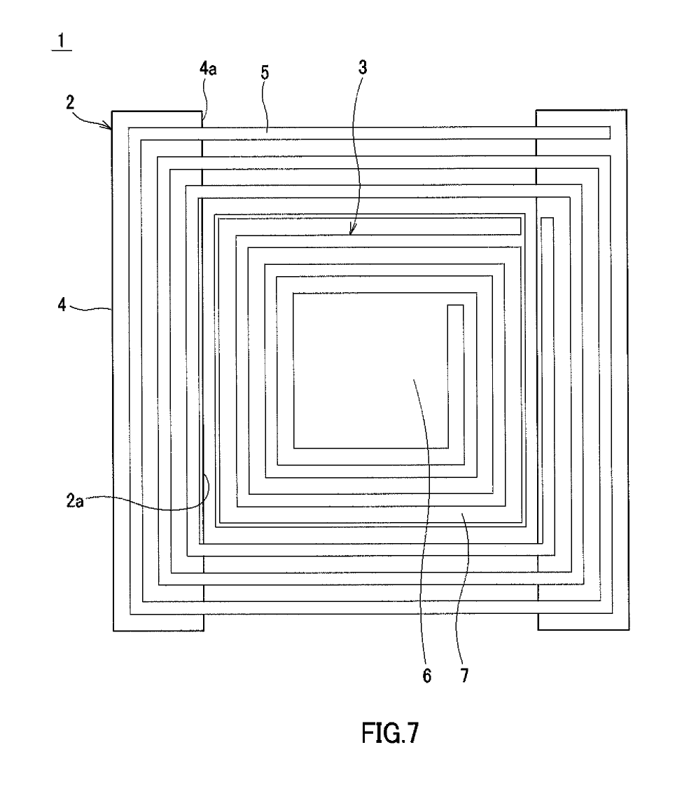

In addition, the opening 4a of the composite coil module 1 is formed between the opposing two sides of the first magnetic sheet 4, as shown in FIG. 7, such that the first magnetic sheet 4 may be divided into two parts by the opening 4a. Each of the divided parts of the first magnetic sheet 4 is placed on the opposing two sides of the antenna coil 5.

In addition, the second magnetic sheet 6 may be arranged between the divided parts of the first magnetic sheet 4 of the composite coil module 1. This makes it possible to increase the area of the second magnetic sheet 6 of the composite coil module 1, and to improve the charging efficiency of the non-contact charging module 3.

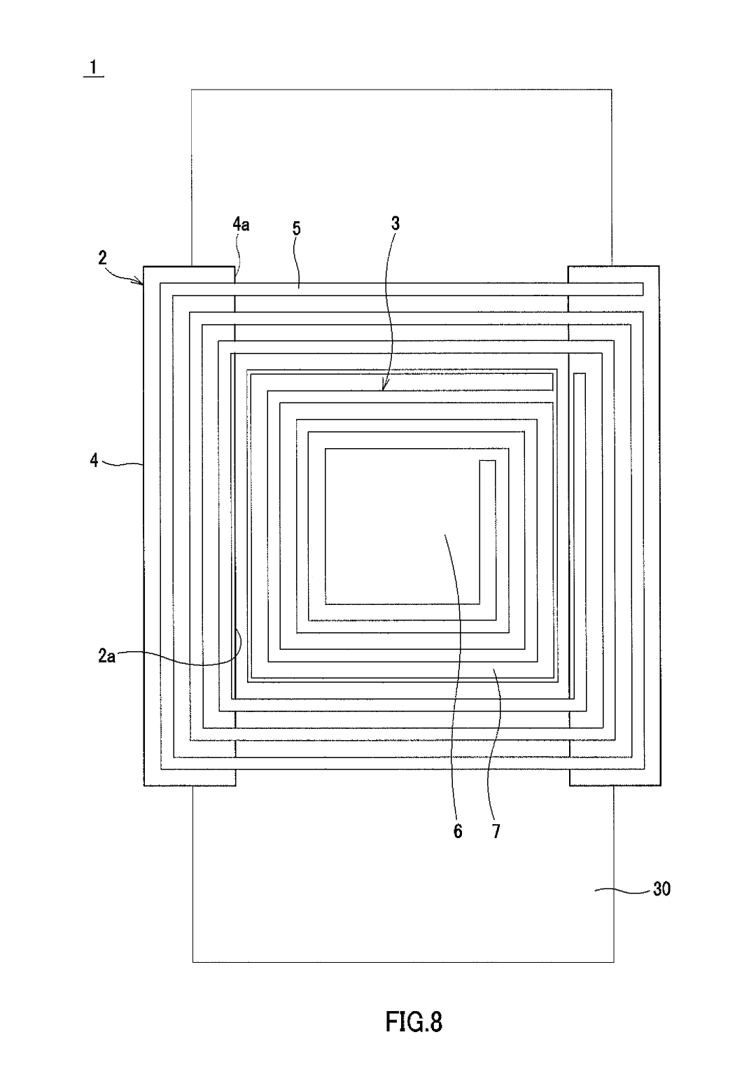

In the above-mentioned case, as shown in FIG. 8, since the opening 4a has been formed between the opposing two sides of the first magnetic sheet 4, it is preferable that the first magnetic sheet 4 is divided into two parts by the opening 4a, while at least one of the divided parts of the first magnetic sheet 4 is arranged along a side edge of a metal plate 30 in the portable apparatus in which the composite coil module 1 is incorporated.

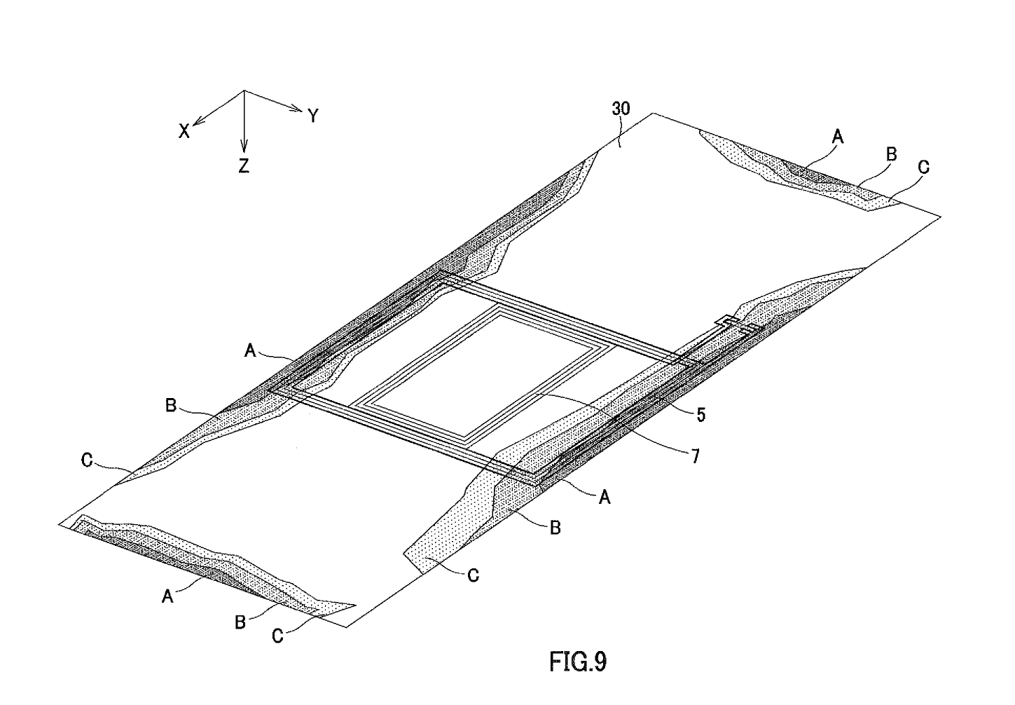

In other words, the composite coil module 1 is placed on the metal plate 30 such as a reinforcing plate for the battery pack and/or the housing of the apparatus in the portable apparatus, and each of the divided parts of the first magnetic sheet 4 is arranged along both of the side edges of the metal plate 30. When considering a magnetic field distribution in the portable apparatus, as shown in FIG. 9, the magnetic flux toward the metal plate 30 flows toward both of the side edges along the plate surface of the metal plate 30, and increases the intensity of the magnetic field on both of the side edges of the metal plate 30. In FIG. 9, A indicates a strong magnetic field area, B indicates a magnetic field weaker than A, and C indicates a magnetic field weaker than B. Arranging the first magnetic sheet 4 in the strong magnetic field area A in the composite coil module 1 makes it possible to efficiently draw large magnetic flux and improve the communication characteristics of the antenna module 2.

Further, the second magnetic sheet 6 can be arranged between the divided parts of the first magnetic sheet 4 in the composite coil module 1 to increase the area of the second magnetic sheet 6 and further improve the charging efficiency of the non-contact charging module 3.

In addition, arranging both of the divided parts of the first magnetic sheet 4 of the composite coil module 1 along the opposing two side edges of the metal plate 30 in the portable apparatus to which the composite coil module 1 has been incorporated makes it possible to further improve the communication characteristics of the antenna module 2.

[Others]

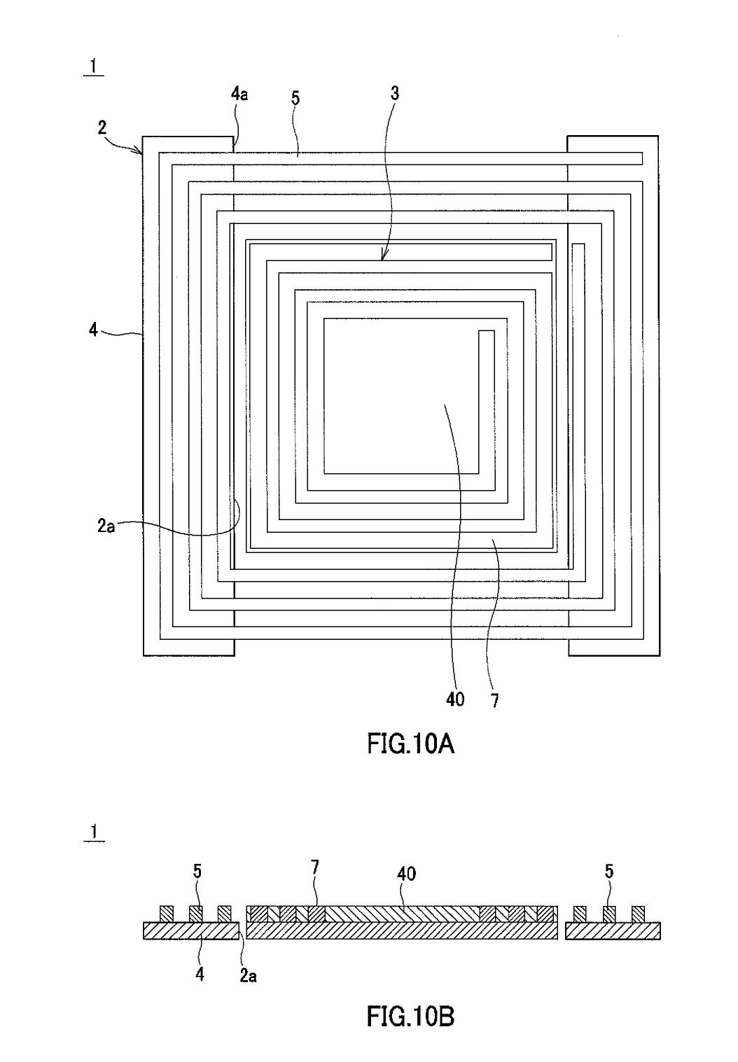

It is noted that the non-contact charging module 3 may be formed in such a manner that the non-contact charging coil 7 is coated by a magnetic resin layer 40, as shown in FIGS. 10A and 10B.

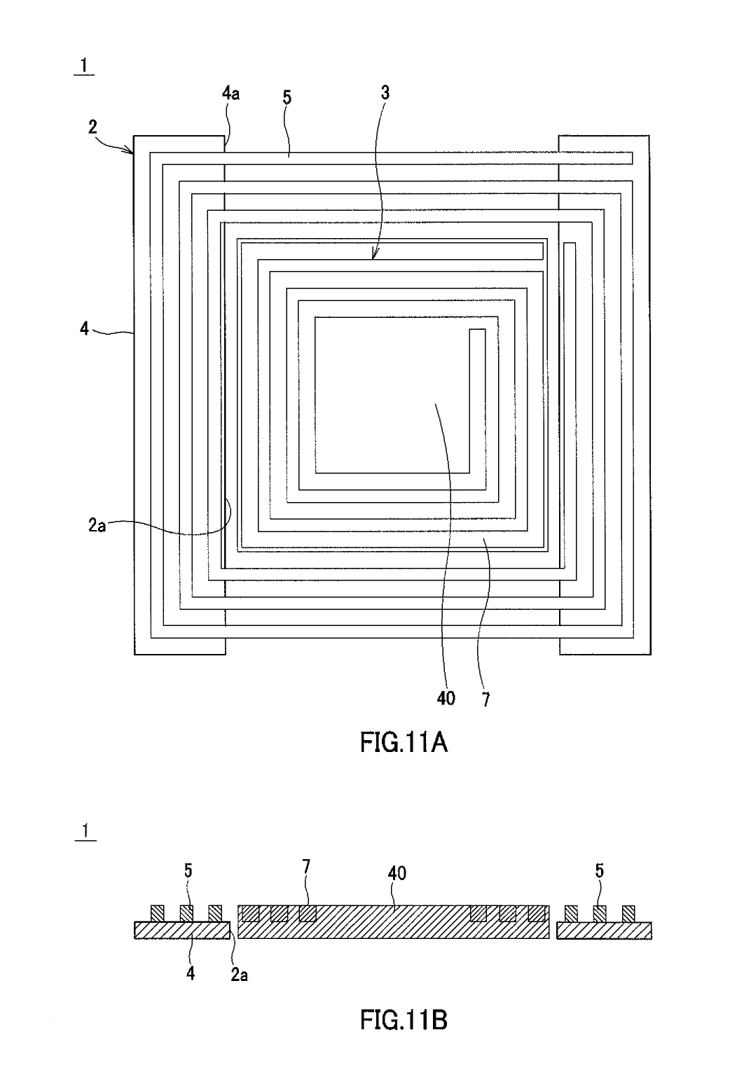

Similar to the first magnetic sheet 4 and the second magnetic sheet 6 described above, the magnetic resin layer 40 includes the magnetic particles made of the soft magnetic powder and resins as binders. In addition, the magnetic resin layer 40 may also be formed, as shown in FIGS. 10A and 10B, by the magnetic particles and the binder material different from those of the second magnetic sheet 6 of the non-contact charging module 3. Alternatively, as shown in FIGS. 11A and 11B, the magnetic resin layer 40, therefore, may be formed by the magnetic particles and the binders similar to those of the second magnetic sheet 6 by embedding the non-contact charging coil 7 in a resin composition containing the magnetic particles that constitute the second magnetic sheet 6 in formation of the second magnetic sheet 6.

Examples of the magnetic particles used may include oxide magnetic bodies such as ferrite, crystal or fine crystal based magnetic bodies such as Fe—, Co—, Ni—, Fe—Ni—, Fe—Co—, Fe—Al—, Fe—Si—, Fe—Si—Al— and Fe—Ni—Si—Al-based magnetic body; or amorphous metal magnetic bodies such as Fe—Si—B—, Fe—Si—B—C—, Co—Si—B—, Co—Zr, Co—Nb and Co—Ta-based magnetic body.

The magnetic particles may be formed by spherical or flat powder having a particle diameter of about a few μm to a few tens of μm. Alternatively, crushed powder may be mixed. For the metal magnetic body mentioned above, the complex magnetic permeability has a frequency characteristic, and a loss is generated due to the skin effect when the operating frequency is increased. It is, therefore, preferable to adjust the particle diameter and the shape of the particles according to the frequency band to be used. In addition, the inductance value of the composite coil module 1 is determined depending on a real part magnetic permeability of magnetic body (may be merely referred to as magnetic permeability, hereinafter). The magnetic permeability is adjustable according to a mixture ratio of the magnetic particles and the resin. The relationship between an average magnetic permeability of the magnetic resin layer 40 and the permeability of the magnetic particles to be blended generally complies with a logarithm rule relative to the amount to be blended. It is, therefore, preferable to set a volume filling ratio of 40 vol % or more at which the interaction among particles increases. It is noted that a thermal conduction characteristic of the magnetic resin layer 40 also improves with an increase of the filling ratio of the magnetic particles.

In addition, the magnetic resin layer 40 may not be limited to be made of a single magnetic material, and two types or more of magnetic materials may be mixed or stacked in a multilayer. In addition, the magnetic resin layer 40 may be made of the same magnetic material, mixed with more than one materials of different particle diameters and/or shapes of the magnetic particles, or alternatively formed in a multilayered structure.

Resins and the like that are curable by heat, ultraviolet rays and the like may be used as the binders. The binders used may be made of a well-known material including resins such as an epoxy resin, a phenol resin, a melamine resin, a urea resin and an unsaturated polyester or rubbers such as a silicone rubber, a urethane rubber, an acrylic rubber, a butyl rubber and an ethylene propylene rubber. It is noted that an appropriate amount of surface treatment agent such as a flame retardant, a reaction control agent, a crosslinking agent, or a silane coupling agent, may be added to the above-mentioned resins or rubbers in the binder material.

### REFERENCE SYMBOLS

1 Composite coil module
2 Antenna module
2a Aperture
3 Non-contact charging module
4 First magnetic sheet
4a Opening
5 Antenna coil
6 Second magnetic sheet
7 Non-contact charging coil
10 Flexible substrate
20 Conducting wire
30 Metal plate
40 Magnetic resin layer
60 Portable telephone
61 Housing
70 Wireless communication system
71 Reader/writer
72 Antenna
73 Memory module
74 Control board
80 Non-contact charging system
81 Battery pack
82 Charging device
83 Power transmission coil
84 Power transmission control board

1. A composite coil module, comprising:
a first coil module including a first magnetic sheet made of a first magnetic material, and a first loop coil provided on the first magnetic sheet and wound in a plane; and
a second coil module including a second magnetic sheet made of a second magnetic material different from the magnetic material of the first magnetic sheet, and a
second loop coil provided on the second magnetic sheet and wound in a plane, wherein the first magnetic sheet is not provided and the second coil module is provided inside the first loop coil.

2. The composite coil module according to claim 1, wherein
the first magnetic sheet is formed with an opening that draws the second loop coil to the outside over inner and outer peripheries of the first loop coil.

3. The composite coil module according to claim 1, wherein
the first magnetic sheet is opened with a width equal to or wider than a width of the second coil module in the direction of inner and outer peripheries of the first loop coil, and the second coil module is also provided in the opening.

4. The composite coil module according to claim 3, wherein
the opening is formed between opposing two sides of the first magnetic sheet, and the first magnetic sheet is divided into two parts by the opening.

5. The composite coil module according to claim 1, wherein
the first coil module is a coil module for non-contact communication, and
the second coil module is a coil module for non-contact charging.

6. The composite coil module according to claim 1, wherein
the second loop coil of the second coil module is coated by a magnetic resin layer including a magnetic material.

7. The composite coil module according to claim 5, wherein
the second loop coil of the second coil module is coated by a magnetic resin layer containing a magnetic material.

8. A portable apparatus comprising a composite coil module mounted in a housing of the apparatus, wherein
the composite coil module includes
a first coil module including a first magnetic sheet made of a first magnetic material, and a first loop coil provided on the first magnetic sheet and wound in a plane,
a second coil module including a second magnetic sheet made of a second magnetic material different from the magnetic material of the first magnetic sheet, and a second loop coil provided on the second magnetic sheet and wound in a plane, wherein
the first magnetic sheet is not provided and the second coil module is provided inside the first loop coil.

9. The portable apparatus according to claim 8, wherein
the composite coil module is placed on a metal member provided in a housing of an electronic apparatus, and
at least one side of the first coil module formed in a substantially rectangularity is located in the vicinity of one side edge of the metal member.

10. The portable apparatus according to claim 9, wherein
opposing two sides of the first coil module are located in the vicinity of opposing two side edges of the metal member.

11. The composite coil module according to claim 2, wherein
the first coil module is a coil module for non-contact communication, and
the second coil module is a coil module for non-contact charging.

12. The composite coil module according to claim 3, wherein
the first coil module is a coil module for non-contact communication, and
the second coil module is a coil module for non-contact charging.

13. The composite coil module according to claim 4, wherein
the first coil module is a coil module for non-contact communication, and
the second coil module is a coil module for non-contact charging.
